(19) United States
(12) Patent Application Publication
(10) Pub. No.: US 2005/0212716 A1
(43) Pub. Date: Sep. 29, 2005

(54) Wall-sized computer display

(75) Inventors: Roy Feigel, Austin, TX (US); Barry Feigenbaum, Austin, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/809,582

(22) Filed: Mar. 25, 2004

(51) Int. Cl. G09G 5/00

(52) U.S. Cl. 345/1.1

(57) ABSTRACT

The present invention provides for rendering a display over a plurality of graphical interfaces. A column number associated with each member of a plurality of display devices is assigned. A row number associated with each member of a plurality of display devices is assigned. An image to be displayed on at least one of the plurality of display devices is generated. A plurality of segments from the generated image is generated. A first and second offset for the at least one of the plurality of display devices are generated. At least two segments of the image devices, as a function of the first and second offset, are selected. The at least two selected segments on the at least two display devices are displayed. Through the use of software to perform many of these functions, flexibility of distribution between client computer and server computers can be had.

### TECHNICAL FIELD

The invention relates generally to video displays and, more particularly, to video displays that use a plurality of graphical devices.

### BACKGROUND

There are a number of reasons that people would want to have large print or figures generated by a computer and a projector. For instance, a projected screen image could be generated, and gaming events or other graphical data, such as flight simulations, could be displayed across the projected screen. One use of particular interest is for persons with disabilities (PwDs) especially those persons with low vision. The projector screen could be a large size, such as the size of a wall or theater screen.

However, there are problem with conventional technological devices. One such problem concerns the resolution of the resulting displayed computer screen which is kept constant as the projection size increases, but with magnification upon a wall through projection, there are fewer pixels per unit area, each pixel being magnified and/or stretched. This results in a larger pixel size in a unit area, thereby leading to less resolution of pixels per area.

One conventional solution is to use a plasma and/or an LCD display. Generally, a plasma display can show as much resolution as can be calculated by the computer. However, large plasma displays can be prohibitively expensive and currently do not exist with high enough resolution. Furthermore, they typically use expensive, dedicated equipment that is out of the reach of many consumers.

A second conventional solution is to aggregate a plurality of displays, and display an image, such as a still image or a video, across these displays. However, there are at least three problems with conventional image display systems of this type.

A first problem is that there can be distinct borders between different displays that intersect the video image. These borders of the displays, such as computer screens, can interfere with the viewer's enjoyment or appreciation of the projected image.

A second problem is that conventional systems that display an image across multiple displays does not increase the absolute resolution, and decreases the effective resolution. In other words, an image, such as a video image, typically has a given resolution, which often is not fully realized on a display. For instance, if the image has a resolution of 3000×4000 pixels, this is reduced down to a lower number, such as 512×256, on a video screen. In conventional systems, the absolute resolution, however, when the image is displayed across a plurality of screens, assuming the plurality has sufficient resolution, remains the same. In other words, there is still 3000×4000 pixel information displayed across a plurality of screens.

Because the absolute number of pixels (the absolute resolution) remains constant, and this absolute number of pixels is distributed over more than one video screen, the relative resolution decreases. Relative resolution can be generally defined as the number of pixels of a given area divided by that area. In conventional technology, this leads to a loss of relative resolution, which can be undesirable to the viewer.

A third problem is that conventional systems that display an image across multiple displays is the price of such systems. Such systems can cost the retail buyer in the hundreds of thousands of dollars, which is well beyond the reach of many typical consumers.

Therefore, there is a need for a large display with high resolution that addresses at least some of the problems associated with conventional plasma or grid displays.

### SUMMARY OF THE INVENTION

The present invention provides for rendering a display over a plurality of graphical interfaces. A column number associated with each member of a plurality of display devices is assigned. A row number associated with each member of a plurality of display devices is assigned. An image to be displayed on at least one of the plurality of display devices is generated. A plurality of segments from the generated image are generated. A first and second offset for at least two of the plurality of display devices are generated. At least one segment of the image devices are selected as a function of the first and second offset. The at least one selected segments is displayed.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a control (client) computer connected to several server computers coupled to projectors, wherein each projector corresponds to its own graphical projection screen in a multi-screen environment;

FIG. 2 schematically depicts a plurality of control (client) computers coupled to several server display computers, wherein each server computer corresponds to its own graphical projection screen in a multi-screen environment;

FIG. 3A schematically illustrates a control (client) computer telling a server to put an image in the upper left hand screen area;

FIG. 3B schematically illustrates a control (client) computer telling a server to put an image in the upper right hand screen area;

FIG. 3C schematically illustrates a control (client) computer telling a server to put an image in the lower left hand screen area;

FIG. 3D schematically illustrates a control (client) computer telling a server to put an image in the lower right hand screen area;

FIG. 4 schematically illustrates a control (client) computer telling a server to put an image to cover all of the projector screens IBM 2843000 App 5.6 (Wall Sized 2-9-04).docon a wall;

FIG. 5 schematically illustrates a control (client) computer telling a server to put an image to cover part of (that is, a subset of) the projector screens on a wall;

FIG. 6 schematically illustrates how an individual screen is assigned an “x” and “y” position of a video segment to be illustrated upon a screen;

FIG. 7 illustrates a virtual video game image rendered over a plurality of screens; and

FIG. 8 illustrates a plurality of different images illustrated over a plurality of screens.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an CPU (central processing unit). The processing unit may also be one of many processing units that share the computational load according to some methodology or algorithm developed for a given computational device. For the remainder of this description, all references to processors shall use the term CPU whether the CPU is the sole computational element in the device or whether the CPU is sharing the computational element with other CPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

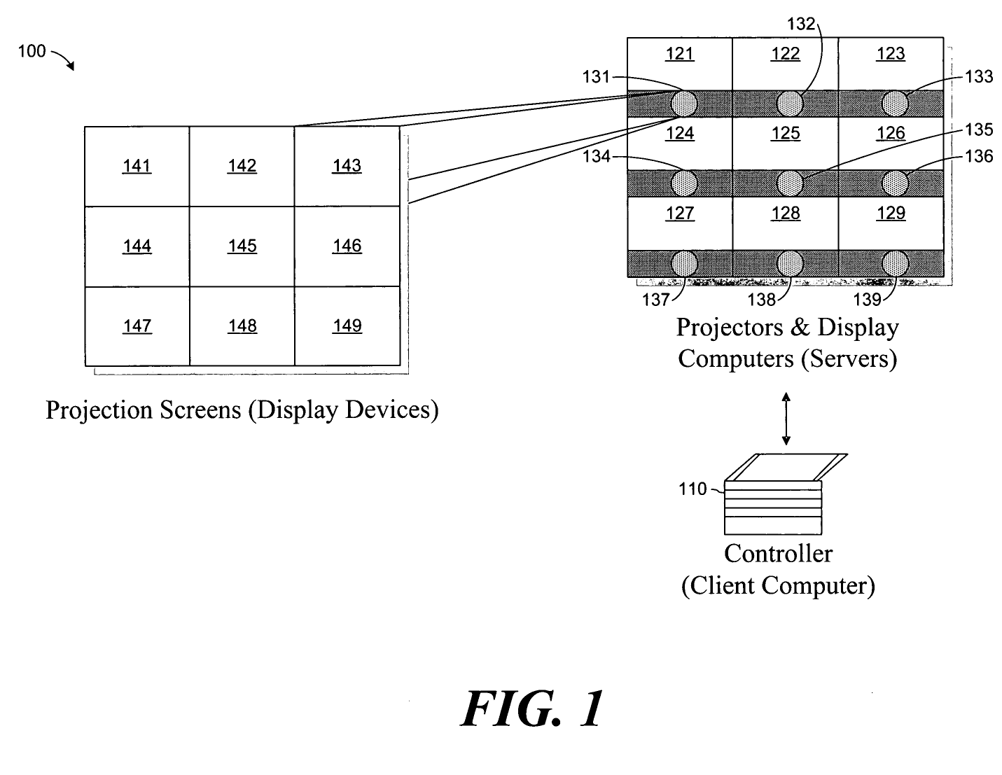

Turning to FIG. 1, disclosed is a system 100. The system 100 has a control (client) computer 110 coupled to display (server) computer 121 through 129. Each display computer has its own projector 131 through 139. For instance, display computer 121 has a projector 131, the display computer 122 has a projector 132, and so on. Each projector 131 to 139 is configurable to project an image onto its own corresponding screen 141-149, respectively. For instance, projector 131 corresponds to screen 141, projector 132 corresponds to screen 142, and so on.

Generally, the system 100 provides for segmenting large-sized and high-resolution multi media “content” such as video images, for example, and then assigning an individual computer screen projector to each part of the segmented image, and then projecting that image onto a wall or other surface. One reason for doing this is that multimedia content can generate much more pixel rendition information than can fit in one 1024×768 screen, a typical conventional computer screen size, for example.

In conventional technology, the pixel rendition information above the 1024×768 (or some other screen size) was lost, as the content was rescaled to fit downwards into the 1024×768 extent. Generally, by having multiple projectors 131-139 arranged in a grid 120 (M×N arrangement), each assigned to its own computer screen of a portion of an image to be rendered, resolution of graphical images can be increased instead to an arbitrary size by adding more projectors, thereby allowing for the reduction of pixel size. The achieved resolution can be defined as the size of an individual projected computer screen×the number of computers in the grid. For example, using a 3 wide×4 high grid and a 1024×768 screen size this achieves an effective resolution of 3072×3072.

In FIG. 1, the control computer 110 generates graphical data to be displayed, and conveys the graphical data to the display computers 121 to 139, and hence to projectors 131 to 139. In FIG. 1, each projector 131 to 139 has its own computer 121 to 129, respectively, which is generating the pixel resolution for that portion of the large scale figure to be displayed on each individual computer screen, referred to for ease of illustration as a “segment”.

In the system 100, the image, such as of an airplane, is sent to servers 121-129. Each server 121-129 has stored within it knowledge of its column and row number within the grid 120. Each server 121-129 is also told or has otherwise stored within it its “x” and “y” offset. Generally, the x and y offset can be defined as corresponding to part of the original image that is to be displayed. For instance, a server at column 0, row 0 121 (upper left) would also probably display the part of the original image corresponding to 0,0 at screen 141. Furthermore, the segmenting can be dynamic. In other words, the segment is defined during the time the graphical image is rendered, and is not pre-defined for the system before the image is rendered. This dynamic segmentation can occur at the client or the server.

However, if for some reason the end user wanted to show the part of the image from the lower right of the image in the column 0, row 0 server 141, the x and y offset to server 121 would say −2, −2, are multiplied by the width (for x) & height (for y) of the grid cells (that is, segWidth and segHeight), to calculate offsets into the virtual image to correspond to the image that would have otherwise been associated with projection screen 149. In other words, although typically the row and column of a projector and the image it projects are the same, an end user can create a jigsaw puzzle or cookie cutter type display wherein segments of the images are assigned to projectors other than in the order that was created with the original image.

Alternatively, the client sections the image to be sent to each display computer of the image by a control computer (client) 110 and assigned to an individual/particular display (“server”) computer 121 to 129 or a subset of display computers 121 to 129. Then, each display computer 121 to 129 does its own rendering, and has its own image projected onto its assigned screen 141 to 149 of the screen 140.

Alternatively, the server 121-129 knows its own column and row information, and is told by the client 110 the height and width of the entire virtual image. From this information, it can then determine what part of the image to display on the screen, in the absence of overriding x and y offset information from the client 110. In a further embodiment, the multimedia information has been already stored within each of the server processors 121 129, and the client 110 sends a pointer, such as an URL, to the selected server 121 to 129, and the server 121 to 129 then determines what graphical information to display.

The computers 121 to 129 are connected in a network, such as a TCP/IP network. In this network, each server 121 to 129 uses a Java program that uses TCP/IP sockets, and interprets a protocol based upon serialized Java objects, and control a Graphical User Interface (GUI) frame, in which the server 121 to 129 presents the various content types using technologies such as Java Swing, Java Advanced Imaging and Java Media Frameworks. However, those of skill in the art understand that other, non-Java implementations are possible.

Furthermore, the use of servers associated with the various projector screens allow for pre-existing or “off the shelf” components to display a virtual image appearing over a plurality of screens. This can be a significant saving in cost. In other words, instead of using dedicated hardware to display an image over a plurality of screens, pre-existing components, such as off-the shelf servers. In one exemplayry embodiment, inexpensive IBM ThinkPad™ laptop computers were used as the servers], can be configured to accept and aid in rendering their sections of the virtual image. In a further embodiment, virtual images, such as disclosed in FIG. 1, can be used for enlarging medical x-rays, text on books to be read by the visually handicapped, video game images, video or DVD images such of airplanes, flight simulations, and so on.

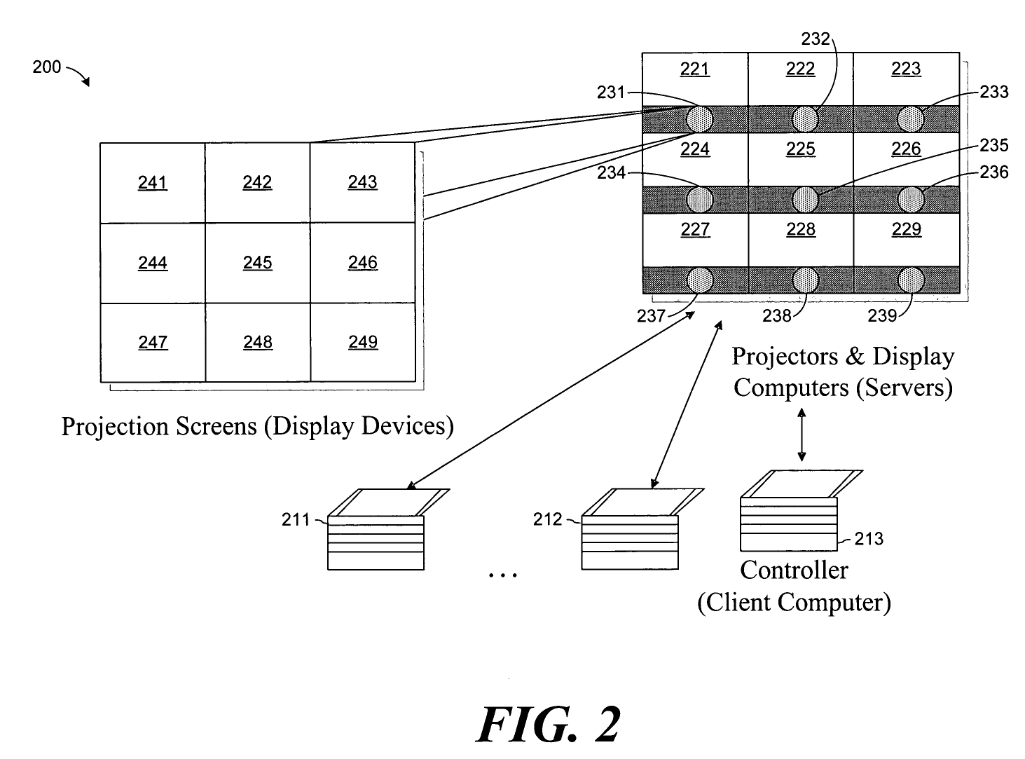

Turning now to FIG. 2 which schematically depicts a system 200 of a plurality of control (client) computers coupled to server display computer, wherein each server computer corresponds to its own graphical projection screen in a multi-screen environment. In FIG. 2, a plurality of clients/controllers 211, 212, 213 are coupled to a bank of servers 121 to 129.

Following is an example of non-inclusive Control code for controlling a plurality of projector servers, sent by the controller, is as follows:

```
      def commandSubset (self, command, extent, size, params=None,
prefix=None):
        # prepare selected additional parameter values
        srow, scol, erow, ecol = extent
        rows = erow − srow + 1
        cols = ecol − scol + 1
        iw, ih = size
        if iw <= 0 or ih <= 0: print “Unknown size”, (iw, ih)
        sw, sh = self.segSize
        xRatio = float(sw) / float(iw)
        yRatio = float(sh) / float(ih)
        # prepare parameters to send to server
```

| | |
|---|---|
| if params is None: | xparams = { } |
| else: | xparams = params.copy( ) |

```
        xparams[“rows”] = rows
        xparams[“columns”] = cols
        xparams[“numcells”] = rows * cols
        xparams[“xRatio”] = xRatio
        xparams[“yRatio”] = yRatio
        # send the specified command to each server in the
specified extent
        for row in range(srow, erow + 1):
          for col in range(scol, ecol + 1):
            # let each server know its position
            xparams[“x”] = (col − scol) * sw
            xparams[“y”] = (row − srow) * sh
            xparams[“row”] = row
            xparams[“column”] = col
            self.send(command, (row, col), xparams, prefix)
```

The above is Jython computer code for sending the size of a computer display with commands from a client controller 212 to a server 221-229. Within the code, “command” is the type of function to be performed by the server, such as display images display GUI component, display video, speed up video, stretch video and so on. “Extent” defines the upper left screen to be displayed to the lower right screen to be displayed. In other words, which of the projectors are to be used for displaying a particular image. “Size” is the size of the image to be displayed on each individual screen. “Params” are additional information that are sent from the client to the server, such as what other information is to be sent to the server, such as minimum and maximum pixel replacement rates, and so on. “Xparams” correspond to the particular mechanisms used to calculate particular parameters with a local copy of the parameters received from a controller 210-212 augmented with parameters generated locally by this code.

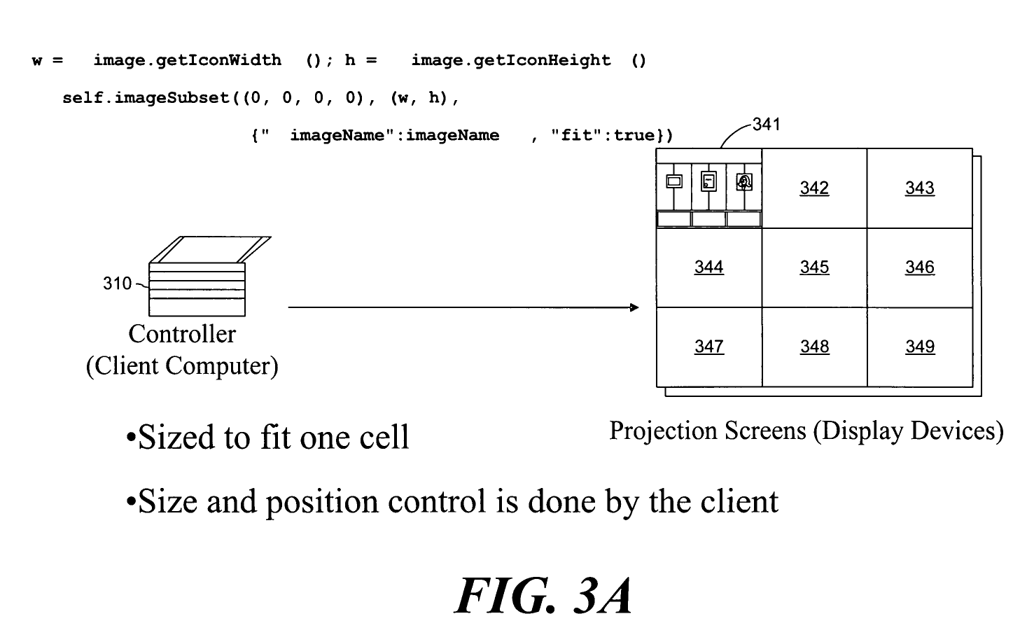

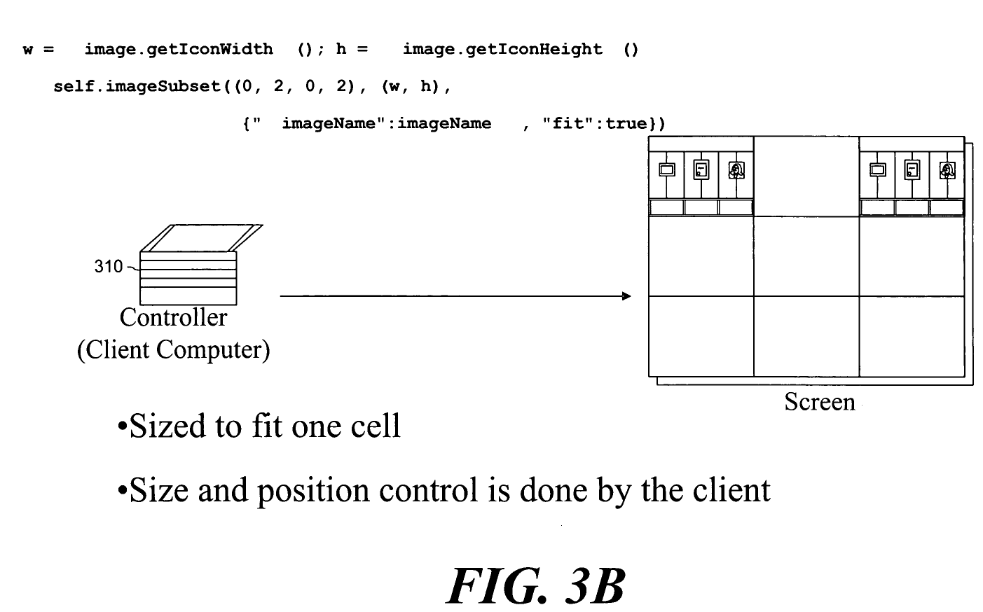

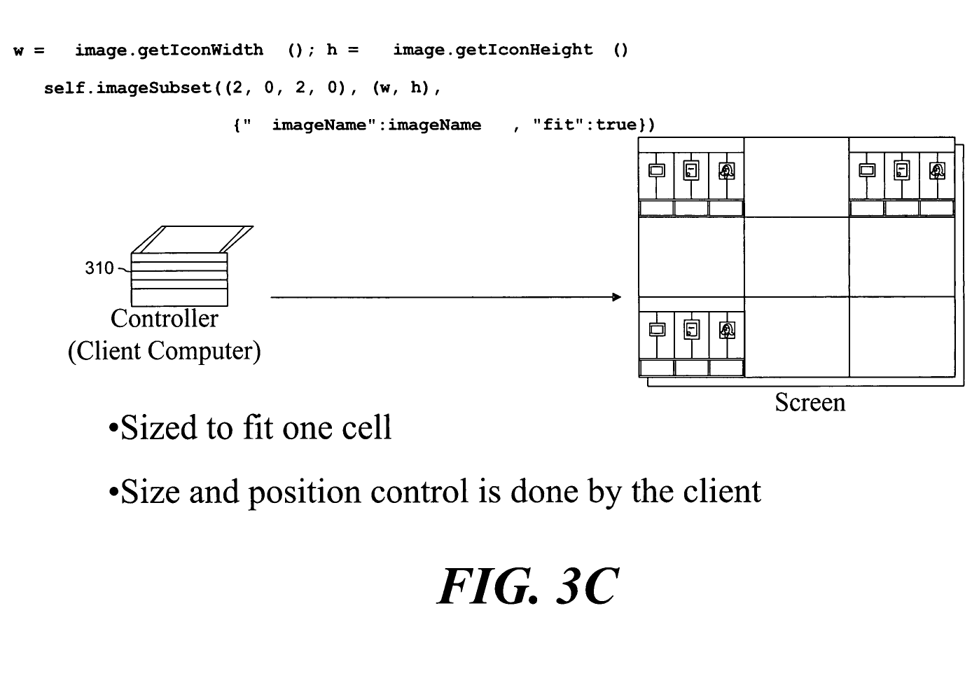

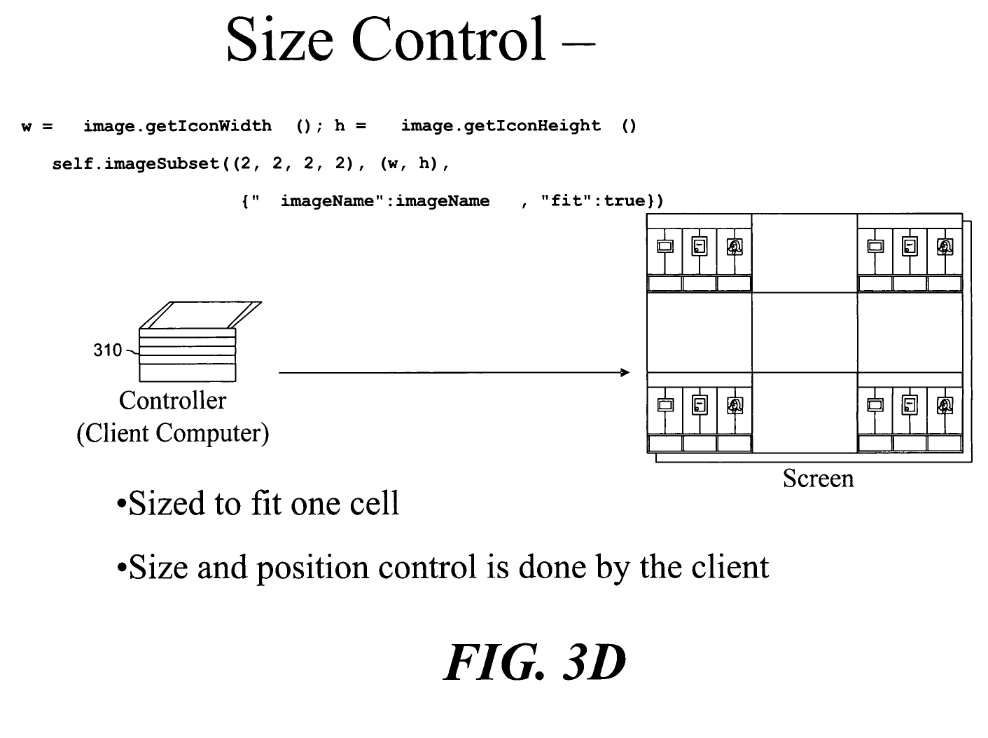

Turning now to FIG. 3A, disclosed is pseudo-code for the controller 110 to command the display the same image on a cell. The code of FIG. 3A reads:

```
w = image.getIconWidth( ) ; h = image.getIconHeight( )
    self.imageSubset ((0,0,0,0), (w,h),
        (“imageName”; imagename, fit=true)
```

Generally, the code works as follows. “W” & “h” are the (natural) dimensions of the actual image. The self.imageSubset (0,0,0,0) corresponds to how the image is set up. The first two numbers (0,0 . . . ) represent the starting segment, and the last two numbers (. . . 0,0) represent the ending segment, wherein each segment is has its own assigned screen. This above code represents the upper left screen being created. Hence, projector screen 341 is turned on. “ImageName”:imageName is the name of the image that is sent from the control to the server for each screen. Other parameters are within the scope of the system 300.

The following Jython code is a representative, but not exhaustive, set of functions that interface between the client 310 and a server on a per command basis. The code “self.client” is a reference to a service object that performs low-level communication functions between the client 311 and the grid of servers. For example, the “sendVideo” service below uses the “commandSubset” function described above:

```
  def sendImage (self, extent, dims, params):
    self.client.imageSubset(extent, dims, params)
def preloadImage (self, extent, params):
    self.client.preloadSubset(extent, params)
def sendVideo (self, extent, params):
    self.client.playVideoAll(extent, params)
```

As is illustrated, the “self.client.imageSubset” sends the “extent” which indicates the servers which are used to generate the virtual image, (that is, from which of the screens does the virtual image and from which of the screens does the virtual image end), and the “params” code sends various commands to the server which the server exactly how to process the images that are sent to it. In FIG. 3A, the size equals the size of one projector screen. However, the size can also indicate that the less than the projector cell 341-349 size.

Each projector cell 341-349, however, can be independently controlled by the controller 311. In other words, the control of each projector cell 341-349 is controlled by the controller 341, and the content on each display 141 can be a duplicate copy, an individual copy, or a part of a larger video image that is displayed across multiple screens 341 to 349. FIGS. 3A to 3D illustrate the control of different projector screen over time. In the illustrated example, different screens 341, 343, 347, 349 are turned on consecutively in time. However, these screens 341-349 can be controlled independently of one another.

Turning now to FIG. 3B, the upper right screen 343 is turned on at (0,2,0,2), as a result of the illustrated “self.imageSubset”, command, which is issued after the “self.imageSubset” command issued in FIG. 3A. Fit=true is one parameter among many that could be used, and tells the server that only one screen is necessary to display the entire virtual image, as opposed to using two or more screens to display the virtual image.

Turning now to FIG. 3C, the upper right screen 343 is turned on at (2,0,2,0), as a result of the illustrated “self.imagesubet” command, which is issued after the “self.imageSubset” command issued in FIG. 3B.

Turning now to FIG. 3D, the upper right screen 343 is turned on at (2,2,2,2) here, as a result of the illustrated “self.imagesubet” command, which is issued after the “self.imageSubset” command issued in FIG. 3C.

Generally, in FIGS. 3A-3D, the extent values {(0,0,0,0) is one extent, (0,2,0,2) is another extent, and so on} tell which servers 341 to 349 to project an image onto their corresponding screens. Although not illustrated, with each of the servers that are enabled by the “extent” command, the controller 310 can also send an independent x-offset and y-offset value to the enabled server, which would indicate which part of the virtual image is to be displayed.

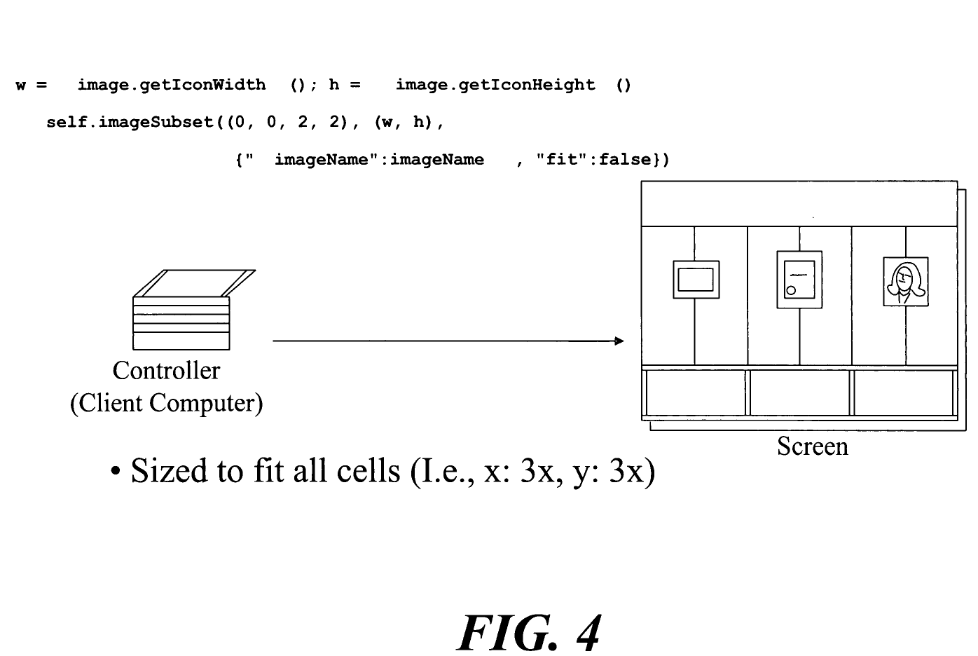

Turning now to FIG. 4, illustrated is a content distributed over a plurality of independent video screens. The code “self.imageSubset((0,0,2,2), (w,h)) says the image starts at position 0,0 and ends at position 2,2. Hence, one ends up with a larger image.

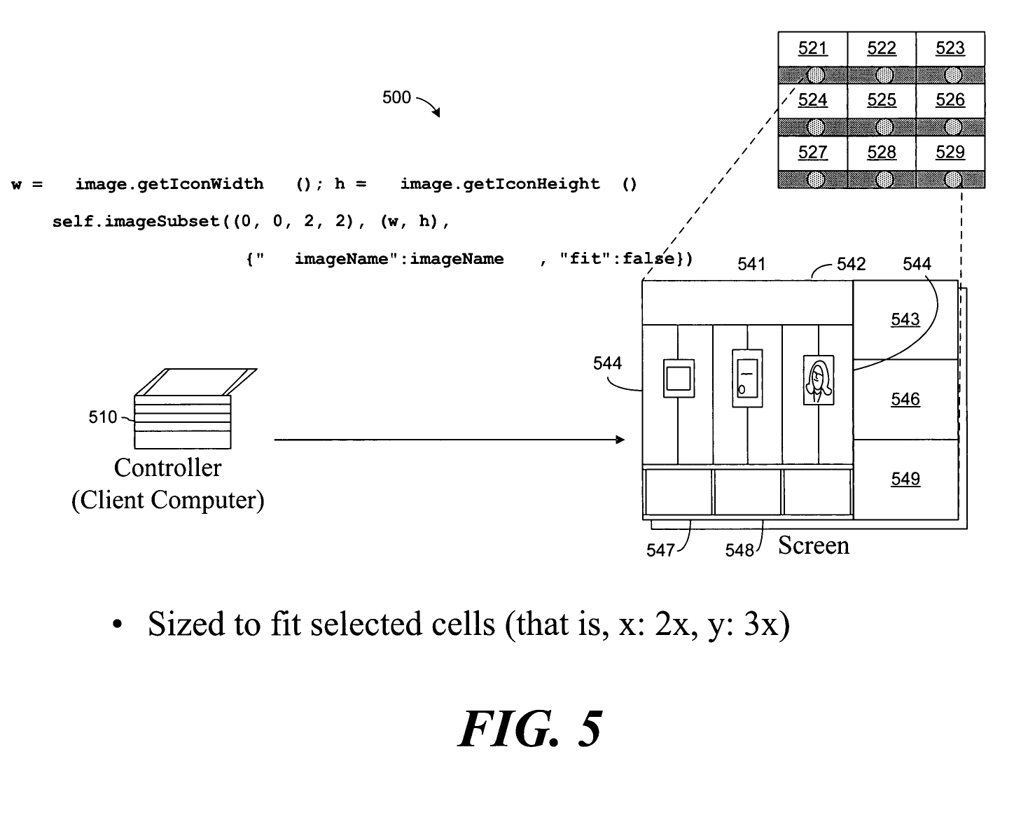

Turning now to FIG. 5, illustrated is a system 500 in which the size of the image projected on the plurality of screens 541, 542, 544, 545, 547, 548 is transformed. The different extents of FIGS. 3, 4 and 5 illustrate some of the many options for placement and sizing of content across one or more segments over time.

The display of FIG. 5 is stretched with “self.images (0,0,1,2) (w,h) is stretched from 0,0 (the left hand corner 541 down to 1,2 (projector 548).

The following is an example in the Java language of how one of the many commands is processed for displaying media content on the projectors 541 to 549. Although the following code is illustrated as controlled on the server side of the process, much of the control of the projectors 541-549 can be based in the client 510, the servers 521-529, or a combination of the client and the servers. For instance, calculation of the x and y offset can occur in the client, or the server, or from the cooperation of both the client and the server. Similarly, many other parameters can also be calculated or determined in either the client or the server, or both. Generally, this code could be used or adapted to run on either the client or server side. For ease of illustration, the following code is discussed as if it resides and is executed on the servers. However, those of skill in the art understand that much of this code could be run or adapted to run on the client as well.

The following code starts a video stream on display devices 541 to 549.
public Object execute(final SegmentDescriptor sd, final Map params) throws CommandException

In this first part of code, “SegmentDescriptor” (“sd”) describes the segment (that, what part of the multi media information is to be displayed), the “Map params” contains the parameters sent by the client 511. Examples of the “Map params” can be the row and column of a server to be enabled. That is, row r, column c values correlate to a unique server 521-529. However, offset x and offset y correspond to the original part of the virtual image to be displayed on the server.

Code processes the received parameters from the client 511. Generally, the code works as follows. The following is one example, for starting the playing of a video.

final Component c = sd.component; // the GUI
component to hold the video player
final Map state = sd.state;

These above statements tell the server which GUI component to use on its screen. (“state” holds an memory information that lasts beyond the current command into the next command.) In other words, sd.component starts a particular multimedia segment on a particular server.

final int segWidth = ((Integer) state.get (“width”)). intValue( );
final int segHeight = ((Integer) state.get (“height”)).intValue( );

This above code tells the servers the width and height of each individual segment it represents. Typically, it will be the same height as the projected screen, but it does necessarily have to be the same size as the computer screen.

```
// the position of the video relative to other segments
      final Integer x = (Integer)params.get(“x”);
      final Integer y = (Integer)params.get(“y”);
```

The above information is embedded with each piece of segment code and says which offset/position in the virtual image this segment is destined for. In other words, the servers that are enabled by the extent command are then told what the video segment to be displayed by that enabled server is.

// the number of rows/columns in the grid
final Integer rows = (Integer)params.get(“rows”);
final Integer columns = (Integer)params.get(“columns”);

The above defines the total numbers of rows of columns of grids in the system. The above information can be information that is sent from the client to the server, or alternatively stored in the server. In any event, in this embodiment, the servers are made aware of the total number of rows ands columns and their row and column number.

```
// this segment's row, column, width and height
        final Integer row = (Integer)params.get(“row”);
        final Integer column = (Integer)params.get(“column”);
        final Integer width = (Integer)params.get(“width”);
        final Integer height = (Integer)params.get(“height”);
```

The above code defines the specific row and column of this segment and the segment's width and height (typically equal to the segWidth and segHeight calculated above). The params width and height is the same as (w,h), that is, the images actual (not virtual) size. xwidth & xheight below are the virtual sizes.

```
int xwidth = −1, xheight = −1;
if (rows != null && columns != null) {
    xwidth = segWidth * columns.intValue( );
    xheight = segHeight * rows.intValue( );
}
if (width != null && height != null) {
    xwidth = width.intValue( );
    xheight = height.intValue( );
}
```

The above code takes a video clip, and segments it into separate pieces for use by the different servers. In the and server 521, the various row, column values, width values and height values are received from the client 510 or otherwise stored in the various servers. The xwidth (that is, width of the entire image, not just each individual segment) are defined as −1. Xwidth & xheight are the dimensions of the “virtual” image (or in this case video frame) that spans all the selected segments. The above calculations determine the total size of the virtual image, and the individual servers can determine their own x and y offsets, if necessary. The −1 is a special initial value (since nothing can have<0 size) to be used to test for later in the code to see if the xwidth and xheight values have changed the value based on the input parameters. The next part of code states that, if values for row and columns were received, the xwidth and xheight values are the same as the received width and height values.

Then, there is code for determining whether xwidth or xheight have been received or otherwise calculated by the servers. Some sample code for this follows.

final boolean multicell = xwidth >= 0 && xheight >= 0;
String xname = (String)getParameter(params, “name”);
if (xname != null && multicell) {
xname = xname + ‘_’ + row + ‘_’ + column;
}
final String name = xname;

The variable “multicell” is set based on whether or not the xwidth and xheight value have been set by the earlier code. The multicell variable in used later to determine if this request is for a single segment or for multiple segments.

Playing videos can be modified by subsequent commands (for example, paused, resumed, stopped early, and so on). To enable these subsequent commands to find the playing video, it can be given a client-assigned name. In a multicell request that name is made unique per cell by adding the position of the cell as a suffix to the name.

Following are some sample commands that can be used by a server when ordered to present multimedia content by the client. These include play video, pause video, resume video, and so on. Params can also send other information, such as speed of rate of play, and so on.

```
          // get the action to perform: play, pause, resume, etc.
          final String action = (String)getParameter(params,
“action”, “play”);
          // parameters for the player
          final Boolean mute = (Boolean)getParameter(params, “mute”,
Boolean.FALSE);
          final Double rate = (Double)getParameter(params, “rate”,
new Double(1.0));
          final Time startTime = (Time)getParameter(params,
“startTime”);
          final Time stopTime = (Time)getparameter(params,
“stopTime”);
          final Boolean repeat = (Boolean)getParameter(params,
“repeat”, Boolean.FALSE);
          this.repeat = repeat;
          final Boolean autoStop = (Boolean)getParameter(params,
“autoStop”, Boolean.FALSE);
          this.autoStop = autoStop;
          final Integer autoStopDelay =
(Integer)getParameter(params, “autoStopDelay”, new Integer(1000));
          this.autoStopDelay = autoStopDelay;
```

In one embodiment of the system 500, video is displayed by the Microsoft Windows MediaPlayer™, which performs the actual commands for the playing of videos. The MediaPlayer is accessed in Java via the Java Media Frameworks APIs. Following is some code to start the Microsoft Windows MediaPlayer™, The next several code sections are used together to make this happen.

if (action.equals(“play”)) { // start a player requested

The above is an example of the use of specific parameters in computer code to start a video player. In other words, commands, such as play, pause, are processed, and other values of merit are used with these commands to help properly run the program.

The following code is used to get the media segment to the appropriate servers 521-529 in one of two ways. The first part of the code uses a URL, such as found in http code, to get information to be downloaded to servers. The second way is that the code segments are already stored within the servers, and that the filename is used to tell the servers 521-529 which code sequence to access. The MediaLocator is a feature of the Java Media Frameworks API. which finds a video stream. Once the media is located a player (a Java wrapper on the Windows Media Player) is created to later use the show the found media.

The rest of the below code corresponds to various error conditions that can occur if no data with the segment name or other necessary parameters were received by the servers 521 to 529.

```
    try {
    final String fileName = (String) getParameter (params,
“fileName”);
    final String fileUrl = (String)getParameter(params, “fileUrl”);
    MediaLocator ml = null;
      if  (fileUrl != null) {
        ml = new MediaLocator(fileUrl);
            }
      else if (fileName != null) {
        ml = new MediaLocator(new File(fileName).toURI( ).toURL( ));
              }
              if (ml == null) {
              throw new IllegalArgumentException(“missing file
name or URL”);
              }
      prefetchComplete = false;
      setplayer(Manager.createRealizedPlayer(locator));
      viewer = player.getVisualComponent( );
```

The following code is used to determine whether multicell (the use of more than one projector screen to illustrate a video) is used.

```
    // now integrate the player into the GUI
        if (multicell) {
            // use a clip viewer to segment the content
            ClipViewer cv = new ClipViewer(x.intValue( ), y.intValue( ),
segWidth, segHeight);
            viewer.setLocation(−segWidth * column.intValue( ), −
segHeight * row.intValue( ));
            viewer.setSize(xwidth, xheight);
            viewer.doLayout( );
            cv.add(viewer);
            view = cv;)
```

The above code is invoked if there is a multicell assignment. The codes' name is clipviewer. Generally, clipviewer allows for the presentation of a segment of video code. Each cell receives the x and y values corresponding to which segmented image is to be displayed. Furthermore, the segWidth and SegHeight values were calculated previously, and correspond the size of the segment's computer display. The viewer.setlocation is a subroutine that uses column and width values to calculate the size of the entire virtual image that is to be displayed across various cells 541 to 549.

However, if there is only one projector cell to be used for a code segment, the following code is used instead.

```
else {
        // show the content normal size in one segment
        if (viewer instanceof JPanel) {
            view = (JPanel)viewer;
        else {
            JPanel p = new JPanel(new BorderLayout( ));
            p.add(viewer);
            view = p;
        }
      }
```

The above code can be described as existing in two parts. The server needs to “register”, a specific component type, a JPanel, in order to have work with various component, so if the MediaPlayer gave a JPanel it will be used for the registration, else the server creates a Jpanel, encapsulate information the MediaPlayer gave the server in it, and use the JPanel the server created. The first “if” clause refers to the case where the video has an associated JPanel, and the second if clause refers to the case when there is no associated Jpanel.

Following is code for replacing one video code segment with a second video code segment, used in the Java Swing.

```
SwingUtilities.invokeLater(
  new Runnable( ) {
    public void run( ) {
      registerPlayer(sd, player, view);
      c.repaint( );
      player.start( );
    }
  });
```

The following code is part of the ClipViewer referenced above. It is used by the servers to determine the individual servers 521 to 529 received “x” and “y” offset coordinates to position the content based on the received “x” and “y” offset coordinates. Then the contents are actually painted to the screen.

```
  protected int x;
  public int getTranslationX( )  {
          return x;
      }
      public void setTranslationX(int x)  {
          this.x = x;
      }
      protected int y;
      public int getTranslationY( )  {
          return y;
      }
      public void setTranslationY(int y)  {
          this.y = y;
      }
      public void setTranslation(int x, int y)  {
          setTranslationX(x);
          setTranslationY(y);
      }
      protected double scale;
      public double getScale( )  {
          return scale;
      }
      public void setscale(double scale)  {
          this.scale = scale;
      }
  public ClipViewer(int xlateX, int xlateY, int width, int height,
double scale)  {
          setLocation(0, 0);
          setSize(width, height);
          setTranslation(xlateX, xlateY);
          setScale(scale);
```

In other words, with the above commands, each server 521-529 determines what part of the received code is to be displayed upon its respective cell display.

Scaling is performed by the setScale function. Generally, scaling can be defined as setting the scale within a particular screen. The above code can allow a user to scale up the scale on a particular projector screen.

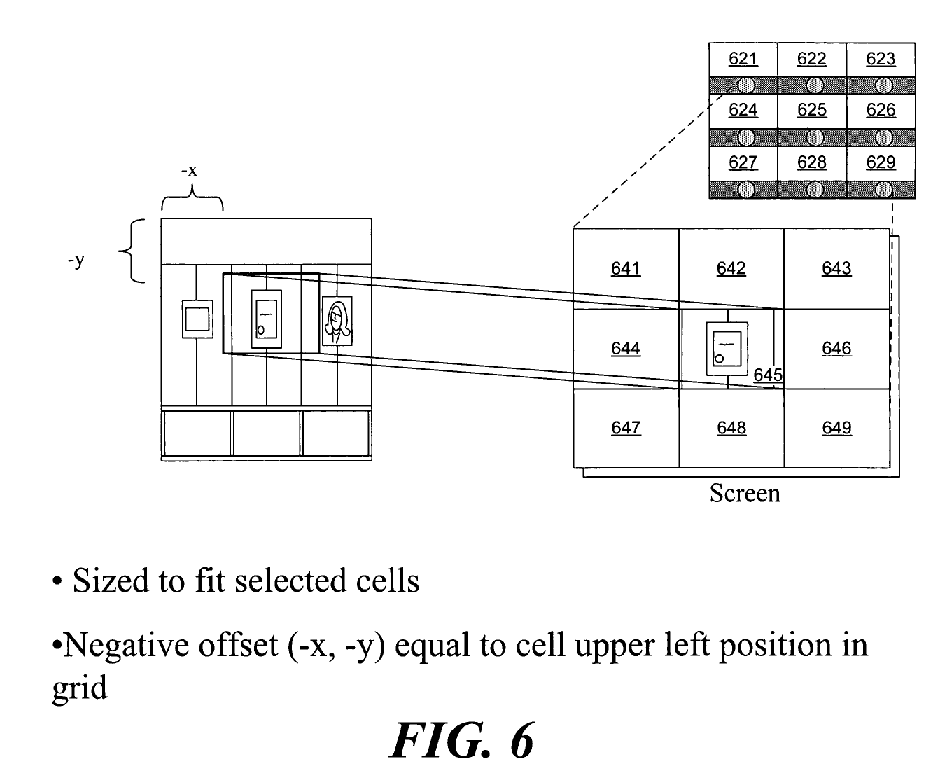

Turning now to FIG. 6, illustrated is the mapping between the x and y coordinate received by each server and the projection of a segmented image onto screens 641-649, respectively. For instance, each server 621-629, each with its own corresponding screen 641 to 649, has its own defined rows and columns, but an offset can be calculated to cause the picture to align with the screen to create a normal (vs. jigsaw puzzle) layout. The offset is defined by its “−x” value and “−y” value, and correlates to what part of the virtual image is to be displayed on the projectors screens 641-649.

Following is code for use with creating the individual graphics content within the different video displays 640.

```
public void paintChildren(Graphics g) {
    Graphics2D g2 = (Graphics2D)g.create( );
    try {
        g2.clipRect(0, 0, getWidth( ), getHeight( ));
        g2.translate(−x, −y).
        if (scale > 0.0) {
            g2.scale(scale, scale);
            }
        super.paintChildren(g2);
    }
    finally {
        g2.dispose( );
    }
}
```

In other words, the above program creates the individual video objects that are used across a plurality of screens, such as shown in FIGS. 4 and 5. In Java, the following implements the shaded box of FIG. 6.

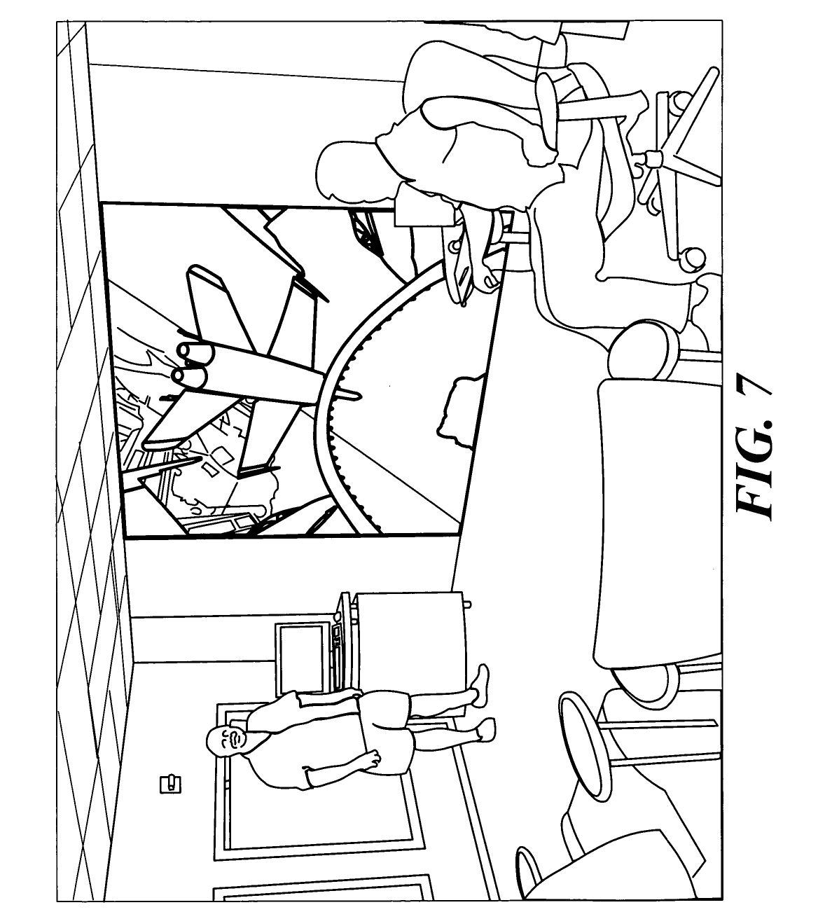

Turning now to FIG. 7, illustrated is a virtual images generated from snapshot of a jet fighter, a “Blue Angel”. However, such an image could also be one such as generated by a flight simulator. As is illustrated, the virtual image of the jet fighter generated is wall-sized, and has a resolution of 3072 by 3072, although those of skill in the art will recognize that other resolutions are within the scope of the present invention. An example of this kind of display can be found in FIG. 4.

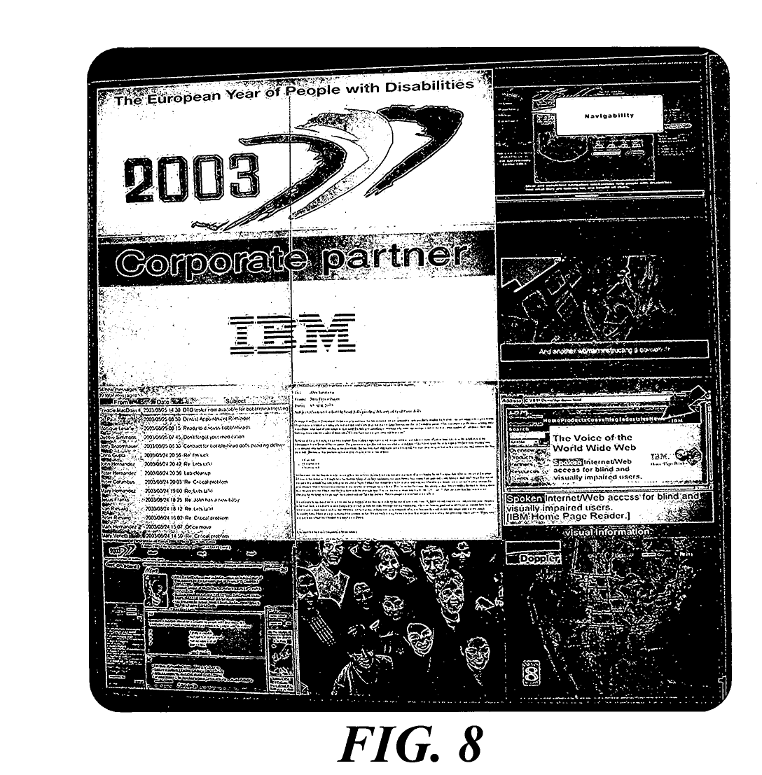

Turning now to FIG. 8, illustrated is a wall sized display showing differing images on its various projectors. These can be similar to the various different images that are shown on the different projector screens of FIG. 3D.

In FIG. 8, the four upper left screens display a corporate logo or logos, such as could be found in a PowerPoint® presentation. The right hand side screens, from top to bottom, show different video images displayed on the projectors, such as from cable TV. The left hand side, second up from bottom screen shows various emails an individual has, and the screen to the right of that is the text of one particular selected email. The bottom left hand screen illustrates a web page selected by a user through the use of a browser, and the bottom middle screen shows a photograph slide of a crowd of people, such as could be received from a web camera.

In further embodiments, in FIGS. 1-8, the screens of the system 100 are to be synchronized to one another, both in start-up and in execution. Although synchronization is described in the present description in respect to FIG. 1, those of skill in the art understand that a the synchronization can apply to FIGS. 1-8.

In a first embodiment, the control/client computer provides the master control over displays 141-149. The control computer 110 sends a start signal, and the projectors display their individual graphics.

However, in order for synchronization of the start time to occur, differences between controller 120 clock time and server 121-129 server clock time must be accounted for. For instance, the control 110 computer could select a certain start time, expressed as clock “ticks”, such as “123456789000” for each of the display computers 121-129 to display graphics content on their respective projectors 141-149. However, the display/server computers 121-129 can be set for a slightly different time than the controller 110, as each display computer 121-129 can have an independent clock. If all display/server computers 121-129 are commanded to start at the same time using the same reference time, errors in start time synchronization could be noted by the viewer, as the virtual image on screens 141-149 could be out of synchronization with one another.

In order for the viewer not to notice any errors in start-time synchronization, the time lag between screen 141-149 initialization, is at most one half of the time each video frame is on the screen. For instance, if there are 30 frames per second on a projector screen 141-149, the time lag between projector start time is to he constrained at 1/60^{th} a second, or the end user could notice errors. Initialization of playing a segment on a screen 141-149 must be started with synchronization that is more accurate than human perception, which is less than a tenth of a second in any event.

In the system 100, start time synchronization can be performed as follows. The control computer 110 sends a message, a “start_time_synch” message to each display computer 121-129. The “start_time_synch” message conveys what the control computer 110 measures the time to be. This can be done with the use of TCP/IP or NetBios, although other protocols are within the scope of the present invention.

Each display computer 121-129 then records the time generated by the control computer, the “start_time_synch”. Then, each display computer 121-129 compares the received time to its own internal independent clock, and records the difference between its time and the time in the message. This generates a “delta time,” reference value to use on future messages from the control computer, as will be explained below. In a further embodiment, to compensate for any short term irregularities in start_time_synch processing times or transfer times, the synchronization can be repeated and an average delta time, such as mean time, median time, and so on, generated.

In the system 100, a request to play the media or media stream on the screens 141-149 is generated by the control computer 110. Part of the parameters of the request to play is a requested “sync time” or start time. This time should be in the (possible quite near) future. The display computers 121-129 employ the “start_time_synch” and adjust it by the derived delta time, to determine when the media should start in reference a given control computer's measured time. When this derived value equals the time measured by the display computer 121-129, the display computer 121-129 start playing. In the system 100, this means that all projectors 131-139 start playing the video at the start at substantially the same time, that is, within the granularity of the system 100 clock time.

Following is code for averaging the “delta time”, which is referred to as “timeBaseAdjustment”.

```
BigInteger tb= (BigInteger)params.get(“timeBase”);
if (tb != null) {
    long tba = System.currentTimeMillis( ) − tb.longValue( );
    timeBaseAdjustmentsCount++;
    if (timeBaseAdjustmentsCountd <= timeBaseAdjustments.length) {
        timeBaseAdjustments[timeBaseAdjustmentsCount −1] = tba;
        long atba = 0; // compute average
        for (int i= 0; i <timeBaseAdjustmentsCount; i++) {
            atba += timeBaseAdjustments[i];
        }
        timeBaseAdjustment = atba / timeBaseAdjustmentsCount;
    }
}
```

In the above code, the params.get(“timeBase”) initiates checking the local time of the clock of the server 121-129. If the timebase exists (that is, if the local time is measured), the “delta time” is calculated in long tba=System.currentTimeMillis( )−tb.longvalue( ). Then, the count representing the number of tests of the local time measured by the timebase is incremented by one. If the number of adjustments of the time base differences represented by the count is less than or equal to the number of defined time base checks, the server 121-129 then sums the total adjustments made in the measurements of the timecounts, and divides it by the number of measurements taken. Then, timeBaseAdjustment, the “delta time,” is computed as an average.

In the following code, a projector screen is started at a selected time at a syncStart time, the timestamp which was origanlly broadcast by the controller computer 110.

```
    registerPlayer (player, view); // make player visible
    player.prefetch( );// (async) get as close to ready to play as
possible
    if (syncStart != null) { // wait till future start time
      long syncTime = syncStart.longValue( );
    for (long delta = deltaTime (syncTime);
    delta > 0;
    delta = deltaTime(syncTime)) {
    try {Thread.currentThread( ).sleep(delta);}
      cache (interruptedException ie) { }
      }
    }
    player.start( );
```

Regarding the above code, as described earlier in the detailed description, the player is made visible as a GUI to a user or client computer 110. A process is begun by the player prefetch statement to get a projector/display device ready for execution. Meanwhile, the above code waits for a predetermined time for the syncTime to begin. The waiting is performed in a loop. Once the syncTime has occurred, the player is started. All the servers in the loop will start at substantially the same time (assuming that the timer clock resolution is small enough, that is, the tic rate is greater than twice the video change), as the syncTime should have been set far enough in advance to allow all servers time to get set up.

In a further embodiment, synchronization is maintained between the projectors 141-149 through use of a “heartbeat” signal. Through the use of the heartbeat signal, the display computers 121-129 are synchronized through this signal and update the next cycle of the next animation/video, stream. The heartbeat protocol can be implemented using protocols like TCP/IP or NETBIOS. In the system 100, the heartbeat signal can be implemented over reliable channels or unreliable channels. Reliable channels typically eliminate the chance of not receiving sent signals, but tend to have higher overhead and thus can not support as high a rate of signaling as unreliable channels.

In the system 100, for unreliable channels, and in a further embodiment, for reliable channels, each heartbeat signal contains a message that has at least a timestamp and a sequence number. In the system 100, the timing signals can be sent at regular intervals from the control computer 110. These timing signals can occur over either reliable or unreliable transport protocols, (UDP as an example of an unreliable transport protocol). Each heartbeat signal has a timestamp as to the time it was generated and a sequence number. The sequence number corresponds to the number of commands given since initialization, such as how many video displays have been illustrated.

The timestamp and the sequence number are then used by the display/server computer 121-129 to determine if it has missed a command to update or refresh a projector or screen. The display computer 121-129 can then quickly advance the content stream back to the correct place. Thus, out of synchronization conditions are quickly healed.

In both reliable and unreliable data networks, the heartbeat message also typically contains some action code an associated parameters. This allows the display computers 121-129 to have a number of different behaviors driven by the pacing signal. Each display computer uses the action code to help determine which signals to process.

In the system 100, in a further embodiment, a server computer 121-129 listens for received signal messages. The display computer has a list of registered “callback” target to notify when a heartbeat signal is received. When the heartbeat signal is received, the server computer “broadcasts” the heartbeat signal to all of the registered callbacks. The code in the callback generates, or otherwise locates, perhaps in a video file, the next frame of the content stream, and displays it.

The following code, a heartbeat signal is created in the control computer 120 in which is received by the server computers 120-129. The autotimer creates an internal signal within the server 110. The autotimer then initiates PaceRunnable information to be sent to the server at regular tick intervals. The PaceRunnable code sends a signal to the server(s) (identified by “address” and “port”), at regular intervals (based on the “delay” time). The message contains the timeBase, delay and any parameters (including a “command” code). The receiving server(s) adjust the time by the previously defined timeBaseAdjustment value and process the message.

Public synchronized void autoPace (InetAddress address, int port,

long base, long delay, Map params)

throws IOException {
timeBase = base;
autotimer = new Timer (true);

paceRunnable = new PaceRunnable(address, port, base, delay,

params);

autotimer.scheduleAtFixedRate(paceRunnable, 0, delay);

}

The following code, in Java, first defines the various parameters that are to be sent in the PaceRunnable code. This includes the internal port (for UDP IP transfer), the base, (when the server says to start the synchronization), the delay (the time between signals) and the actual data itself, such as where to find information to display video information or a projector.

public class PaceRunnable extends TimerTask
{

:
public PaceRunnable (InetAddress address, int port, long base

long delay, Map data) {

this.address = address;
this.port = port;
this.base = base;
this.delay = delay;
this.indata = data;
}

The following code represents part of the internal workings of the “PaceRunnable” code to send the timing information to the servers. The createMessage creates the actual message for the server, and the send command sends the message. There is also a general-purpose catch exception, which invokes a subroutine, such as an operating system subroutine, to deal with error conditions.

public void run () {

count++;
try {

Map msgdata = createMessage (base, delay, indata, count);
send (address, port, msgdata);

}
catch (Exception e) {

e.printStackTrace) {;
cancel) {);

}

}

}

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as programming any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for rendering a display over a plurality of graphical interfaces, comprising:
assigning a column number associated with each member of a plurality of display devices;
assigning a row number associated with each member of a plurality of display devices;
generating an image to be displayed on at least two of the plurality of display devices;
generating a plurality of segments from the generated image;
generating a first and second offset for at least two of the plurality of display devices;
selecting at least two segments of the image as a function of the first and second offset; and
displaying the at least two selected segments on the at least two display devices.

2. The method of claim 1, further comprising dynamically defining the code segments.

3. The method of claim 2, wherein the dynamically definition occurs at the client.

4. The method of claim 1, wherein the selecting at least one segment of the images is performed by a server.

5. The method of claim 1, wherein the selecting at least one segment of the images is performed by a client.

6. The method of claim 1, wherein a virtual image is displayed over two adjacent screens.

7. The method of claim 1, wherein the row number is equal to the first offset, and the column number is equal to the second offset.

8. The method of claim 1, wherein the first offset is equal to the vertical offset and the second offset is equal to the horizontal offset for at least one of the plurality of display devices.

9. The method of claim 1, wherein the first offset is not equal to the vertical offset and the second offset is equal to the horizontal offset for at least one of the plurality of display devices.

10. The method of claim 1, further comprising selecting at least two of the plurality of display devices.

11. The method of claim 1, wherein the step of Generating an image to be displayed on at least two of the plurality of display devices further comprises Generating an image to be displayed on a graphical user interface.

12. The method of claim 1, wherein the step of Generating an image to be displayed on at least two of the plurality of display devices further comprises generating a video image.

13. The method of claim 1, further comprising generating the image in a server coupled to the each display.

14. The method of claim 1, further comprising generating the image in a client coupled to each display.

15. The method of claim 1, wherein the step of segmenting is performed in a server coupled to the display device.

16. The method of claim 1, wherein the step of segmenting is performed in a client coupled to a plurality of servers, the plurality of servers each coupled to its own respective display device.

17. The method of claim 1, further comprising synchronizing the plurality of display devices to start execution substantially the same start time.

18. The method of claim 1, further comprising synchronizing the plurality of display devices to display a plurality of images in succession at substantially the same time.

19. A system for displaying a graphical image on a plurality of screens, comprising:
a client computer;
a plurality of server computers coupled to the client computer;
a display of a plurality of graphical devices, wherein each device is coupled to at least one server; and
wherein the client is configured to segment a video image for substantially concurrent rendering by the plurality of server computers.

20. A computer program product for rendering a display over a plurality of graphical interfaces, the computer program product having a medium with a computer program embodied thereon, the computer program comprising:
computer code for assigning a column number associated with each member of a plurality of display devices;
computer code for assigning a row number associated with each member of a plurality of display devices;
computer code for generating an image to be displayed on at least two of the plurality of display devices;
computer code for generating a plurality of segments from the generated image;
computer code for generating a first and second offset for at least two of the plurality of display devices;
computer code for selecting at least two segments of the image as a function of the first and second offset; and
computer code for displaying the at least two selected segments on the at least two display devices.

21. A processor for rendering a display over a plurality of graphical interfaces, the processor including a computer program comprising:
computer code for assigning a column number associated with each member of a plurality of display devices;
computer code for assigning a row number associated with each member of a plurality of display devices;
computer code for generating an image to be displayed on at least two of the plurality of display devices;
computer code for generating a plurality of segments from the generated image;
computer code for generating a first and second offset for at least two of the plurality of display devices;
computer code for selecting at least two segments of the image as a function of the first and second offset; and
computer code for displaying the at least two selected segments on the at least two display devices.
